(19) United States
(12) Patent Application Publication
(10) Pub. No.: US 2026/0018975 A1
(43) Pub. Date: Jan. 15, 2026

(54) INTERNALLY SHUNTING GROUNDING BRUSH ASSEMBLY WITH AXIAL BRUSHES

(71) Applicant: AKTIEBOLAGET SKF, GOTEBORG (SE)

(72) Inventors: Mathieu HUBERT, Ann Arbor, MI (US); Gene Arthur KOVACS, Brighton, MI (US); David Christopher RYBSKI, White Lake, MI (US); Alberto CARLEVARIS, Turin (IT)

(21) Appl. No.: 18/925,344

(22) Filed: Oct. 24, 2024

(30) Foreign Application Priority Data
Jul. 11, 2024 (IT) 102024000016084

(51) Int. Cl. H02K 11/40; H01R 39/24

(52) U.S. Cl. CPC H02K 11/40; H01R 39/24

(57) ABSTRACT

A grounding brush assembly is for an electric machine including a rotatable shaft having a bore, an outer housing, bearing(s) rotatably coupling the shaft with the housing and a fixed shaft extending through the bore of the rotatable shaft and electrically grounded. A conductive base member has a bore sized to receive a portion of the fixed shaft, a centerline and an outer circumferential surface. A conductive brush or brushes are coupled with the base member and includes conductive fibers extending radially outwardly from the outer surface of the base member and axially along the centerline. Each conductive fiber has an inner radial end coupled with the base member and an outer radial end engageable with the inner circumferential surface of the rotatable shaft such that at least one conductive path extends from the rotatable shaft, through the brush and the base member, and to the fixed shaft.

### CROSS-REFERENCE

This application claims priority to Italian patent application no. 102024000016084 filed on Jul. 11, 2024, the contents of which are fully incorporated herein by reference.

### BACKGROUND OF THE INVENTION

The present invention relates to grounding devices for bearings, and more particularly to grounding brush assemblies for shunting current away from bearings.

electric machines, such as an electric motor, a generator, etc., the machine typically includes a shaft rotatable about a central axis, an outer housing and at least one bearing connecting the shaft to a housing. Such bearings generally include an inner ring mounted on the rotatable shaft, an outer ring disposed about the inner ring and engaged with the housing, and a plurality of rolling elements disposed between the inner and outer rings. During operation, electric charge may accumulate on the shaft, which can generate an electric current that passes from the shaft, through the bearing and into the outer housing. These currents can cause damage to the raceways of the inner and outer rings as well as to the rolling elements.

In order to avoid damage to the bearings, it is known to provide a grounding brush assembly that provides a conductive path between the shaft and the housing in order to shunt current away from the bearing(s). Such a grounding brush assembly typically includes a bracket or holder connected with the housing and a brush attached to the bracket/holder and including a plurality of conductive fibers extending radially inwardly from the holder and contacting the outer surface of the shaft, or a sleeve or other member mounted on the shaft. Alternatively, the holder may be mounted on the shaft and have a plurality of radially-outwardly directed fibers engaged with an inner circumferential surface of the housing.

### SUMMARY OF THE INVENTION

In one aspect, the present invention is a grounding brush assembly for an electric machine, the electric machine including a rotatable shaft rotatable about a central axis and having an inner circumferential surface defining a hollow bore, an outer housing, at least one bearing rotatably coupling the shaft with the housing, and a fixed shaft extending through the bore of the rotatable shaft and being electrically grounded. The grounding brush assembly comprises a conductive base member having a bore sized to receive a portion of the fixed shaft, a centerline coaxially alignable with the central axis and an outer circumferential surface. At least one conductive brush is coupled with the base member and including a plurality of conductive fibers extending radially outwardly from the outer circumferential surface of the base member and spaced axially along the centerline. Each conductive fiber has an inner radial end coupled with the base member and an outer radial end engageable with the inner circumferential surface of the rotatable shaft such that at least one electrically conductive path extends from the rotatable shaft, through the brush and the base member, and to the fixed shaft.

Preferably, the conductive base member includes a generally cylindrical body having an outer surface providing the outer circumferential surface of the base member, an inner circumferential surface defining the bore of the base member, a first axial end and an opposing second axial end. The cylindrical body of the base member preferably has at least one axial groove extending radially inwardly from the outer circumferential surface of the cylindrical body and axially between the first and second axial ends, the radial inner end of each one of the plurality of conductive fibers of the at least one conductive brush being disposed within the at least one axial groove and the plurality of conductive fibers being spaced along the at least one axial groove. Further, the at least one axial groove preferably includes a plurality of axial grooves spaced circumferentially about the centerline, each one of the plurality of axial grooves extending radially inwardly from the outer circumferential surface of the cylindrical body and axially between the first and second axial ends of the cylindrical body, and the at least one conductive brush includes a plurality of conductive brushes, each one of the plurality of conductive brushes being disposed within a separate one of the plurality of axial grooves of the cylindrical body.

Preferably, the at least one conductive brush preferably includes a retainer disposed within the at least one axial groove of the cylindrical body and having a base wall and two spaced apart side walls extending from the base wall so as to define an axial channel, the plurality of conductive fibers of the at least one conductive brush being disposed between and engaged by the two side walls so as to retain the conductive fibers within the axial channel. Furthermore, the grounding brush assembly preferably further comprises at least one centering bearing having an inner ring disposable upon the fixed shaft and an outer ring engageable with the inner circumferential surface of the rotatable shaft, the at least one centering bearing being disposable against or spaced axially apart from the conductive base member and being configured to center the rotatable shaft about the fixed shaft.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of an electric machine including a grounding brush assembly in accordance with the present invention;

FIG. 2 is a perspective view of the grounding brush assembly;

FIG. 3 is an exploded perspective view of the grounding brush assembly; and

FIG. 4 is an end view of the conductive brush assembly.

### DETAILED DESCRIPTION OF THE INVENTION

Certain terminology is used in the following description for convenience only and is not limiting. The words “inner”, “inwardly” and “outer”, “outwardly” refer to directions toward and away from, respectively, a designated centerline or a geometric center of an element being described, the particular meaning being readily apparent from the context of the description. Further, as used herein, the words “connected” and “coupled” are each intended to include direct connections between two members without any other members interposed therebetween and indirect connections between members in which one or more other members are interposed therebetween. The terminology includes the words specifically mentioned above, derivatives thereof, and words of similar import.

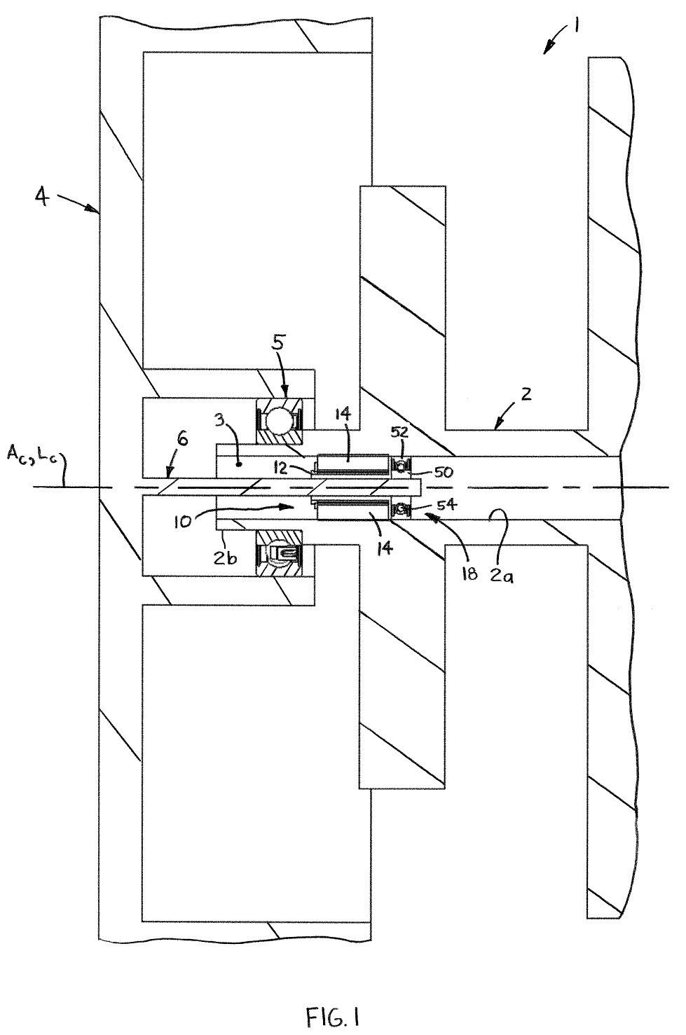

Referring now to the drawings in detail, wherein like numbers are used to indicate like elements throughout, there is shown in FIGS. 1-4 a grounding brush assembly 10 for an electric machine 1. The electric machine 1 includes a rotatable shaft 2 rotatable about a central axis A_{C} and having an inner circumferential surface 2a defining a hollow bore 3, an outer housing 4, at least one bearing 5 rotatably coupling the shaft 2 with the housing 4, and a fixed shaft 6 extending through the bore 3 of the rotatable shaft 2 and being electrically grounded. The grounding brush assembly 10 basically comprises a conductive base member 12 and at least one conductive brush 14 coupled with the base member 12, and preferably includes at least one centering bearing 18 configured to center the rotatable shaft 2 about the fixed shaft 6.

More specifically, the conductive base member 12 having a bore 13 sized to receive a portion of the fixed shaft 6, a centerline Lc coaxially alignable with the central axis A_{C} and an outer circumferential surface 12a. The at least one conductive brush 14 includes a plurality of conductive fibers 20 extending radially outwardly from the outer surface 12a of the base member 12 and axially along the centerline Lc, each conductive fiber 20 being engageable with the inner circumferential surface 2a of the rotatable shaft 2. Specifically, each conductive fiber 20 has an inner radial end 20a coupled with the conductive base member 12, preferably through mutual contact with a brush retainer 40 as described below, and an outer radial end 20b engageable with the inner circumferential surface 2a of the rotatable shaft 2a.

As such, at least one electrically conductive path extends from the rotatable shaft 2, through the at least one conductive brush 14 and the conductive base member 12, and to the fixed shaft 6. With the present grounding brush assembly 10, any charge accumulating on the rotatable shaft 2 flows as an electric current through the assembly 10 and to the fixed shaft 6 rather than passing through the bearing(s) 5 of the electric machine 1. Thereby, damage to the rolling elements and raceways (neither indicated) of the bearing(s) 5 is avoided. Having described the basic elements and functions above, these and other components of the present grounding brush assembly 10 are described in further detail below.

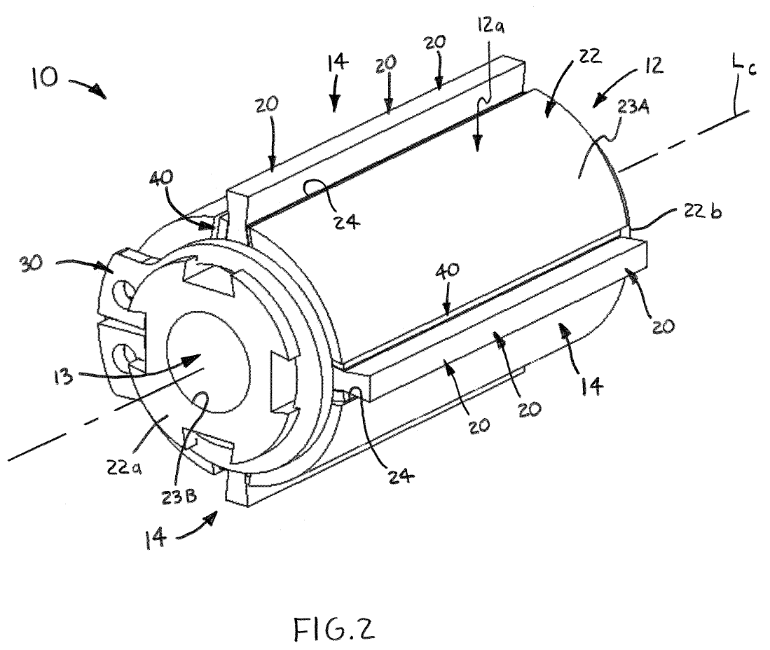

Referring to FIGS. 2-4, the base member 12 includes a generally cylindrical body 22 having an outer surface 23A providing the outer circumferential surface 12a, an inner circumferential surface 23B defining the bore 13 of the base member 12, a first axial end 22a and an opposing second axial end 22b. Preferably, the grounding brush assembly 10 is mounted to the fixed shaft 6 by a friction fit between the inner surface 23B of the cylindrical body 22 and the outer circumferential surface (not indicated) of the shaft 6. The cylindrical body 22 is formed of an electrically conductive material, such as steel, aluminum, a conductive polymer or any other appropriate conductive material. Preferably, the cylindrical body 22 of the base member 12 has at least one axial groove 24 formed in the outer surface 23A of the cylindrical body 22 and extending axially between the first and second axial ends 22a, 22b, respectively. With this structure, the inner end 20a of each one of the plurality of conductive fibers 20 of the at least one conductive brush 14 is disposed within the at least one axial groove 24 and the plurality of fibers 20 are spaced axially along the groove 24.

Most preferably, the cylindrical body 22 of the conductive base member 12 includes a plurality of axial grooves 24 each extending axially between the first and second ends 22a, 22b of the cylindrical body 22 and spaced circumferentially apart about the centerline Lc. Similarly, the at least one conductive brush 14 includes a plurality of conductive brushes 14, with each one of the plurality of conductive brushes 14 being disposed within a separate one of the axial grooves 24 of the cylindrical body 24.

Further, the grounding brush assembly 10 preferably further comprises at least one annular retainer clip 30 engaged with one of the first and second axial ends 22a, 22b of the cylindrical body 22 of the base member 12. The retainer clip 30 is configured to retain the at least one conductive brush 14 disposed within the at least one axial groove 24 of the cylindrical body 22, and preferably retains all of the preferred plurality of conductive brushes 14 with each associated axial groove 24. Preferably, the cylindrical body 22 has an annular groove 26 located adjacent to the one of the first and second axial ends 22a, 22b, and most preferably two annular grooves 26 each formed at a separate one of the axial ends 22a, 22b. Further, the retainer clip 30 is preferably formed as a C-clip disposed within the annular groove 26, and preferably includes two C-clips each disposed within a separate one of the two preferred grooves 26, and are each disposable against an axial end of each brush 14.

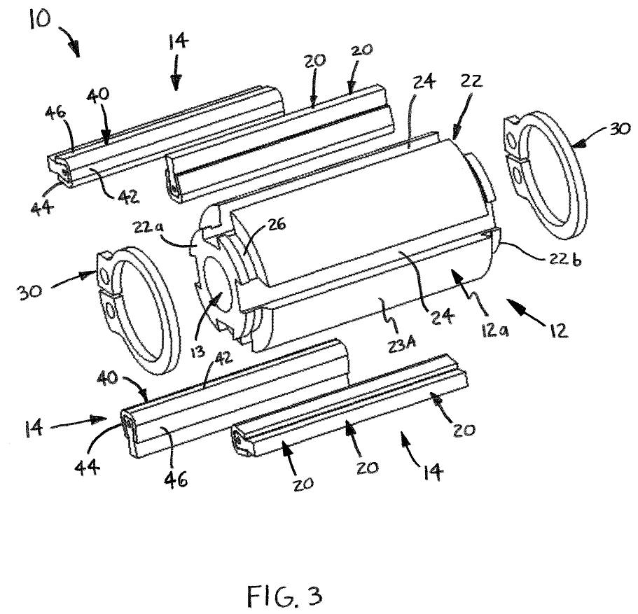

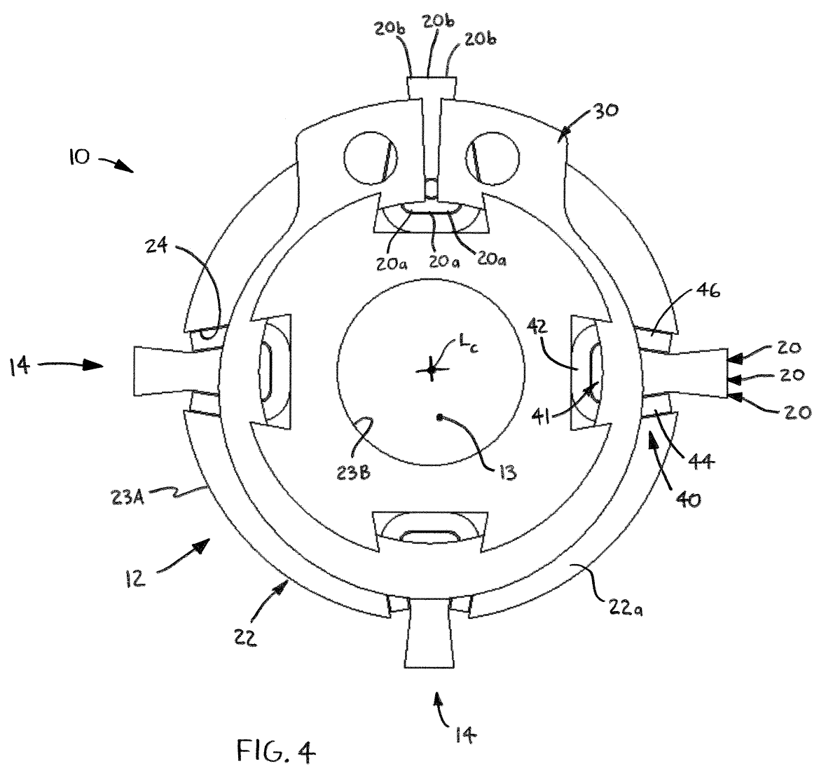

Referring to FIGS. 3 and 4, preferably, each conductive brush 14 preferably includes a retainer 40 with a base wall 42 and two spaced apart side walls 44, 46 each extending from the base wall 40 so as to define an axial channel 41. The plurality of conductive fibers 20 are disposed between and engaged by the two side walls 44, 46 so as to retain the conductive fibers 20 within the axial channel 41. Preferably, the retainer 40 is formed of an electrically conductive material, such as steel, aluminum, a conductive polymer, etc., and each conductive fiber 20 is a strand of an electrically conductive material, preferably carbon but may be formed of steel, aluminum, a conductive polymer, etc.

Although the grounding brush assembly 10 preferably includes one or more conductive brushes 14 each having a plurality of conductive fibers 20, each brush 14 may alternatively be formed as a solid conductive member (not shown) coupled with the conductive base member 12 and having an outer radial end engageable with the inner surface 2a of the rotatable shaft 2. For example, the solid conductive member may be formed as a rectangular strip of an appropriate conductive material positioned so as to extend radially from the conductive body 12 and axially along the centerline Lc of the body 12.

As shown in FIG. 1 and discussed above, the grounding brush assembly 10 preferably comprises at least one centering bearing 18 having an inner ring 50 disposed on the fixed shaft 6 and an outer ring 52 engageable with the inner circumferential surface 2a of the rotatable shaft 2, and preferably includes a plurality of rolling elements 56 disposed between the inner and outer rings 50, 52. The at least one centering bearing 18 is disposed against or spaced axially apart from the conductive base member 12 and functions to couple the rotatable shaft 2 with the fixed shaft 6 so as to stiffen and prevent vibration of the fixed shaft 6, and does not primarily serve to support any loading between the two shafts 2, 6.

With the grounding brush assembly 10 of the present invention, the conductive fibers 20 contact the inner surface 2a of the rotating shaft 2, which has a linear velocity (i.e., tangent to the surface 2a) with a magnitude that is less than the magnitude of the linear velocity at the outer surface 2b of the shaft 2. As such, both friction and wear of the conductive fibers 20 is reduced in comparison with known grounding brush assemblies having conductive fibers contacting a shaft outer surface.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

We claim:

1. A grounding brush assembly for an electric machine, the electric machine including a rotatable shaft rotatable about a central axis and having an inner circumferential surface defining a hollow bore, an outer housing, at least one bearing rotatably coupling the shaft with the housing, and a fixed shaft extending through the bore of the rotatable shaft and being electrically grounded, the grounding brush assembly comprising:
a conductive base member having a bore sized to receive a portion of the fixed shaft, a centerline coaxially alignable with the central axis and an outer circumferential surface; and
at least one conductive brush coupled with the base member and including a plurality of conductive fibers extending radially outwardly from the outer circumferential surface of the base member and spaced axially along the centerline, each conductive fiber having an inner radial end coupled with the base member and an outer radial end engageable with the inner circumferential surface of the rotatable shaft such that at least one electrically conductive path extends from the rotatable shaft, through the brush and the base member, and to the fixed shaft.

2. The grounding brush assembly as recited in claim 1, wherein the conductive base member includes a generally cylindrical body having an outer surface providing the outer circumferential surface of the base member, an inner circumferential surface defining the bore of the base member, a first axial end and an opposing second axial end.

3. The grounding brush assembly as recited in claim 2, wherein the cylindrical body of the base member has at least one axial groove extending radially inwardly from the outer circumferential surface of the cylindrical body and axially between the first and second axial ends, the radial inner end of each one of the plurality of conductive fibers of the at least one conductive brush being disposed within the at least one axial groove and the plurality of conductive fibers being spaced along the at least one axial groove.

4. The grounding brush assembly as recited in claim 3, wherein:
the at least one axial groove of the cylindrical body of the base member includes a plurality of axial grooves spaced circumferentially apart about the centerline, each one of the plurality of axial grooves extending radially inwardly from the outer circumferential surface of the cylindrical body and axially between the first and second axial ends of the cylindrical body; and
the at least one conductive brush includes a plurality of conductive brushes, each one of the plurality of conductive brushes being disposed within a separate one of the plurality of axial grooves of the cylindrical body.

5. The grounding brush assembly as recited in claim 3, wherein the at least one conductive brush includes a retainer disposed within the at least one axial groove of the cylindrical body and having a base wall and two spaced apart side walls extending from the base wall so as to define an axial channel, the plurality of conductive fibers of the at least one conductive brush being disposed between and engaged by the two side walls so as to retain the conductive fibers within the axial channel.

6. The grounding brush assembly as recited in claim 3, wherein the conductive base member further includes at least one annular retainer clip engaged with one of the first and second axial ends of the cylindrical body of the base member and configured to retain the at least one conductive brush disposed within the at least one axial groove of the cylindrical body.

7. The grounding brush assembly as recited in claim 6, wherein the cylindrical body has an annular groove located adjacent to the one of the first and second axial ends of the cylindrical body and the retainer clip is a C-clip disposed within the annular groove and disposable against an axial end of the at least one conductive brush.

8. The grounding brush assembly as recited in claim 1, further comprising at least one centering bearing having an inner ring disposable upon the fixed shaft and an outer ring engageable with the inner circumferential surface of the rotatable shaft, the at least one centering bearing being disposable against or spaced axially apart from the conductive base member and being configured to center the rotatable shaft about the fixed shaft.

9. A grounding brush assembly for an electric machine, the electric machine including a rotatable shaft rotatable about a central axis and having an inner circumferential surface defining a hollow bore, an outer housing, at least one bearing rotatably coupling the shaft with the housing, and a fixed shaft extending through the bore of the rotatable shaft and being electrically grounded, the grounding brush assembly comprising:
a conductive base member having a centerline coaxially alignable with the central axis and including a generally cylindrical body having a first axial end, an opposing second axial end, an outer circumferential surface and an inner circumferential surface defining a bore sized to receive a portion of the fixed shaft; and
at least one conductive brush coupled with the base member and including a plurality of conductive fibers extending radially outwardly from the outer circumferential surface of the base member and spaced axially along the centerline, each conductive fiber being engageable with the inner circumferential surface of the rotatable shaft such that at least one electrically conductive path extends from the rotatable shaft, through the brush and the base member, and to the fixed shaft.

10. The grounding brush assembly as recited in claim 9, wherein each one of the plurality of conductive fibers of the at least one conductive brush has an inner radial end coupled with the cylindrical body of the base member and an outer radial end engageable with the inner circumferential surface of the rotatable shaft.

11. The grounding brush assembly as recited in claim 10, wherein the cylindrical body of the conductive base member has at least one axial groove extending radially inwardly from the outer circumferential surface of the cylindrical body and axially along the centerline between the first and second axial ends, the inner end of each one of the plurality of conductive fibers of the at least one conductive brush being disposed within the at least one axial groove and the plurality of conductive fibers being spaced along the at least one axial groove.

12. The grounding brush assembly as recited in claim 11, wherein:
the at least one axial groove of the cylindrical body of the base member includes a plurality of axial grooves spaced circumferentially apart along the centerline, each one of the plurality of axial grooves extending radially inwardly from the outer circumferential surface of the cylindrical body and axially between the first and second axial ends of the cylindrical body; and
the at least one conductive brush includes a plurality of conductive brushes, each one of the plurality of conductive brushes being disposed within a separate one of the plurality of axial grooves of the cylindrical body.

13. The grounding brush assembly as recited in claim 11, wherein the at least one conductive brush includes a retainer disposed within the at least one axial groove of the cylindrical body and having a base wall and two spaced apart side walls extending from the base wall so as to define an axial channel, the plurality of conductive fibers of the at least one conductive brush being disposed between and engaged by the two side walls so as to retain the conductive fibers within the axial channel.

14. The grounding brush assembly as recited in claim 11, wherein the base member further includes at least one annular retainer clip engaged with one of the first and second axial ends of the cylindrical body of the base member and configured to retain the at least one conductive brush disposed within the at least one axial groove of the cylindrical body.

15. The grounding brush assembly as recited in claim 14, wherein the cylindrical body has an annular groove located adjacent to the one of the first and second axial ends of the cylindrical body and the retainer clip is a C-clip disposed within the annular groove and disposable against an axial end of the at least one conductive brush.

16. The grounding brush assembly as recited in claim 9, further comprising at least one centering bearing having an inner ring disposable upon the fixed shaft and an outer ring engageable with the inner circumferential surface of the rotatable shaft, the at least one centering bearing being disposable against or spaced axially apart from the conductive base member and being configured to center the rotatable shaft about the fixed shaft.
